(19) United States
(12) Patent Application Publication
(10) Pub. No.: US 2006/0256212 A1
(43) Pub. Date: Nov. 16, 2006

(54) Image photographing apparatus, method of storing data for the same, and navigation apparatus using location information included in image data

(75) Inventor: Hyong-uk Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/342,621

(22) Filed: Jan. 31, 2006

(30) Foreign Application Priority Data
May 16, 2005 (KR) 10-2005-0040564

(51) Int. Cl. H04N 5/76

(52) U.S. Cl. 348/231.99

(57) ABSTRACT

An image photographing apparatus using location information, a method of storing data therefor, and a navigation apparatus using the location information included in the image data, are provided. The image photographing apparatus includes a filming unit for photographing an object and providing the image data, a location information providing unit for providing location information of the place where the image data is taken, a control unit for adding location information to an area of the image data, and a storage unit for storing the image data according to the control of the control unit. According to the apparatus and method, a user is required to perform less searching by creating and using the filenames including the location information when the image data is retrieved, thereby saving time, and the image data can be arranged and stored as the user desires, so that the image data can be managed efficiently.

### CROSS-REFERENCE TO RELATED PATENT APPLICATIONS

This application claims the benefit under 35 U.S.C. §119(a) of Korean Patent Application No. 10-2005-0040564, filed in the Korean Intellectual Property Office on May 16, 2005, the entire disclosure of which is incorporated herein by reference.

### BACKGROUND OF THE INVENTION

1. Field of the Invention

The present invention relates to an image photographing apparatus. More particularly, the present invention relates to an image photographing apparatus, a method of storing data for the apparatus, and a navigation apparatus using location information included in image data.

2. Description of the Related Art

Recently, due to the rapidly increasing production of digital content and the expanding capacity of storage devices, portable digital devices have been experiencing wide use. In particular, a digital still camera (DSC) function has been employed in digital cameras, camcorders, mobile phones, portable multimedia players (PMPs), MP3 players, and personal navigation devices. This has enabled the capture of digital images at any place and time with a variety of digital devices having an embedded DSC function.

Generally, an image taken by a digital camera is stored in an image format such as JPG and TIF, with a filename attached to the image. Most recently released digital cameras add a filename complying with a DCF standard. Here, DCF stands for “Design rule for Camera File system” and is a file format suggested as a standard by Japan Electronics and Information Technology Industries Association (JEITA), specifying methods of storing and using data in a digital camera. The advantage of the DCF file format is that a photo taken by a digital camera complying with this DCF file format can be reproduced in other digital camera devices.

FIG. 1 illustrates the structure of directory and file layers according to a conventional DCF file format.

Referring to FIG. 1, DCF files 40 that are taken by a digital camera are stored complying with the DCF file format in a DCF directory 30 that is a subdirectory of a digital camera image (DCIM) directory 20, after filenames are attached to the DCF files 40. Here, the DCIM 20 directory is a subdirectory of the root directory 10 that is the top layer directory.

According to the DCF standard, there is a naming rule to determine directories and filenames. More specifically, a directory name (‘100ABCDE’, ‘102ABCDE’, . . . ) is formed with a number part including 3 numbers, and a letter part including 5 letters. In the number part, any number from 100 to 999 can be used, and in the letter part, any one of ‘A’˜‘Z’, ‘0’˜‘9’, and ‘_’ can be used. Generally, the letter part is given according to a manufacturer or product model. The number part is given by sequentially incrementing the number by 1 according to the order that the directories are generated.

Also, according to the DCF standard, a filename is formed with 8 characters. The filename is formed with a letter part including 4 letters, a number part including numbers, and an extension. The letter part is formed with capital letters and the number part is formed with numbers from “0001” to “9999”. Files in one directory cannot use identical filenames. The letter part is given according to a manufacturer or product model in a manner similar to that of the directory name. The number part is given by sequentially incrementing the number by 1 according to the order that the files are generated.

A process of generating directories and filenames according to the DCF standard will now be explained. When a captured image is to be recorded, first, the DCF image root directory 20 is searched for in order to determine whether or not the directory 20 exists. If the DCIM directory 20 does not exist, it is created, and according to the DCF standard, a lower-level DCF directory 30 is generated. A filename is then given to the DCF directory 30 and DCF files 40 are stored.

Thus, images taken by the conventional digital camera apparatus are stored in a storage unit of the digital camera apparatus with filenames having no particular meaning, such as “SA500001’, ‘SA500002’, and ‘SA500003’. Accordingly, it is difficult for users to remember the filming time and place of the photo using only the filename.

That is, in the conventional digital camera apparatus, due to the filenames allocated according to the above described naming rule, it is inconvenient for users to search for a desired photo when there are many photos or when the photos are old. Users have to view each photo to find the desired photo.

In addition, when files taken by the digital camera are transmitted to a personal computer (PC), the user has to change the filename transmitted to the PC for the convenience of retrieval, because the original filename was generated according to the DCF standard.

Accordingly, a need exists for an apparatus and method for creating and using image data filenames which reduces user search times and allows efficient management of image file data.

### SUMMARY OF THE INVENTION

Embodiments of the present invention have been provided to substantially solve the above and other problems, and provide an image photographing apparatus for storing location information in meta data or in a filename when the image data is generated, and a method therefor.

Embodiments of the present invention also provide a navigation method and apparatus using location information included in image data.

According to an aspect of embodiments of the present invention, an image photographing apparatus is provided comprising a filming unit for photographing an object and providing image data, a location information providing unit for providing location information of the place where the image data is taken, a control unit for adding the location information to a predetermined area of the image data, and a storage unit for storing the image data according to the control of the control unit.

The location information providing unit may receive a global positioning system (GPS) signal and provide location information.

The predetermined area in which the location information may be added comprises a user comment area of meta data.

The control unit may change the filename of the image data so that the location information is included in the filename.

The apparatus may further comprise a mapping unit for receiving an input of coordinate information from the location information providing unit and providing a specific geographical name corresponding to the coordinate information.

According to another aspect of embodiments of the present invention, a method of storing image data taken in an image photographing apparatus is provided comprising the steps of receiving the image data, receiving the location information of the place where the image data is taken, and adding the location information to a predetermined area of the image data.

The predetermined area may comprise a user comment area of meta data.

The location information may comprise coordinate information and/or a specific geographical name corresponding to the coordinate information.

If only coordinate information is included in the location information, the method may further comprise the steps of searching for a specific geographical name corresponding to the coordinate information.

According to still another aspect of embodiments of the present invention, a method of storing image data taken in an image photographing apparatus is provided comprising the steps of receiving the image data, receiving the location information of the place where the image data is taken, and changing the filename so that the location information is included in the filename of the image data.

The predetermined area may comprise a user comment area of meta data.

The location information may comprise at least one of coordinate information and a specific geographical name corresponding to the coordinate information.

If only coordinate information is included in the location information, the method may further comprise the step of searching for a specific geographical name corresponding to the coordinate information.

According to another aspect of embodiments of the present invention, a computer apparatus for receiving and storing a transmitted image data file taken in an image photographing apparatus is provided, the apparatus comprising a filename changing unit for extracting location information on a place where the image data is taken by parsing the location information included in a predetermined area of the image data file and changing the filename so that the location information is included in the filename of the image data, and a storage unit for storing the image data file whose filename is changed.

The predetermined area of the image data file may comprise a user comment area of meta data.

The apparatus may further comprise a geographical name conversion unit for searching for a specific geographical name corresponding to the coordinate information included in the location information and for providing the geographical name.

According to a further aspect of embodiments of the present invention, a method of receiving and storing a transmitted image data file taken in an image photographing apparatus is provided, the method comprising the steps of receiving an image data file from the image photographing apparatus, extracting location information from a predetermined area of the Image data file, and changing the filename of the image data file so that the extracted location information is included in the filename of the image data file.

The predetermined area of the image data file may comprise a user comment area of meta data.

If only coordinate information is included in the location information, the method may further comprise the step of searching for a specific geographical name corresponding to the coordinate information.

According to a further aspect of embodiments of the present invention, a navigation apparatus is provided comprising a storage unit for storing an image data file including location information in a predetermined area therein, a location information extraction unit for extracting the location information from the image data file, a current location detection unit for providing current location information, a display unit for displaying the image data file, and a control unit for calculating a path to a destination where the image was taken, by using the current location information provided by the current location detection unit and the location information stored in the image data file, if an image displayed on the display unit is selected as a destination.

The predetermined area of the image data file including the location information may comprise a user comment area of meta data.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 illustrates a structure of directory and file layers according to a conventional DCF file format;

FIG. 2 is a block diagram illustrating a structure of an image photographing apparatus according to an embodiment of the present invention;

FIG. 3 illustrates an example of a meta data format for image data taken by an image photographing apparatus according to an embodiment of the present invention;

FIG. 4 is a flowchart illustrating an embodiment of a method of storing image data of an image photographing apparatus according to an embodiment of the present invention;

FIG. 5 is a flowchart illustrating an embodiment of a method of storing image data of an image photographing apparatus according to another embodiment of the present invention;

FIG. 6 is a block diagram illustrating an image photographing apparatus connected to a computer apparatus, according to an embodiment of the present invention;

FIG. 7 is a flowchart illustrating a process of transmitting and receiving data between an image photographing apparatus and a computer apparatus, and changing a file name according to an embodiment of the present invention; and

FIG. 8 is a block diagram illustrating a navigation apparatus using location information included in image data according to an embodiment of the present invention.

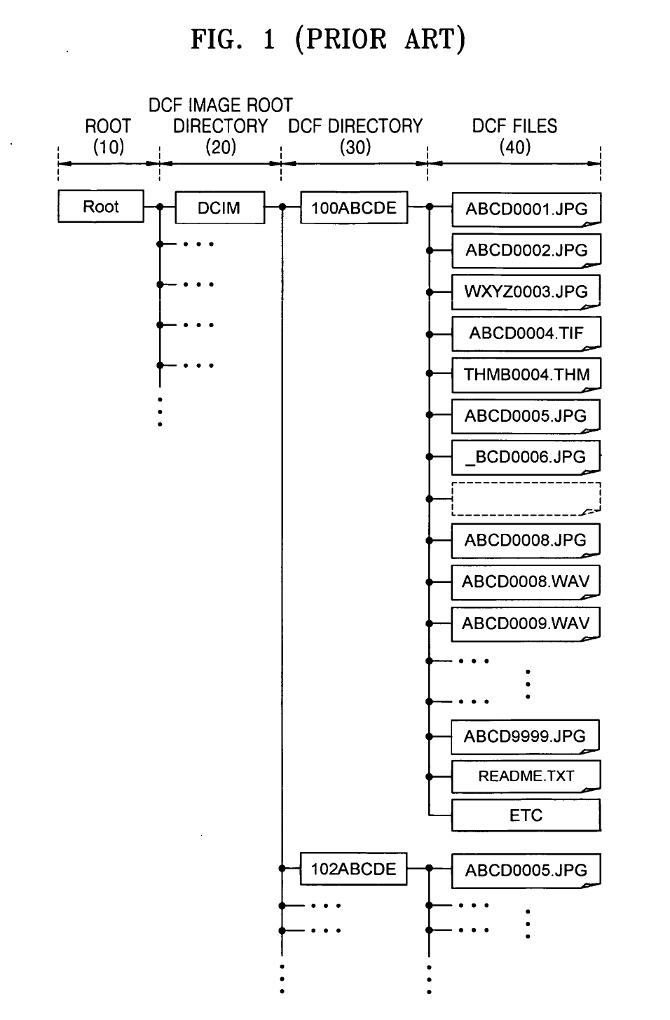

Throughout the drawings, like reference numerals will be understood to refer to like parts, components and structures.

### DETAILED DESCRIPTION OF THE EXEMPLARY EMBODIMENTS

The present invention will now be described more fully with reference to the accompanying drawings, in which exemplary embodiments of the invention are shown.

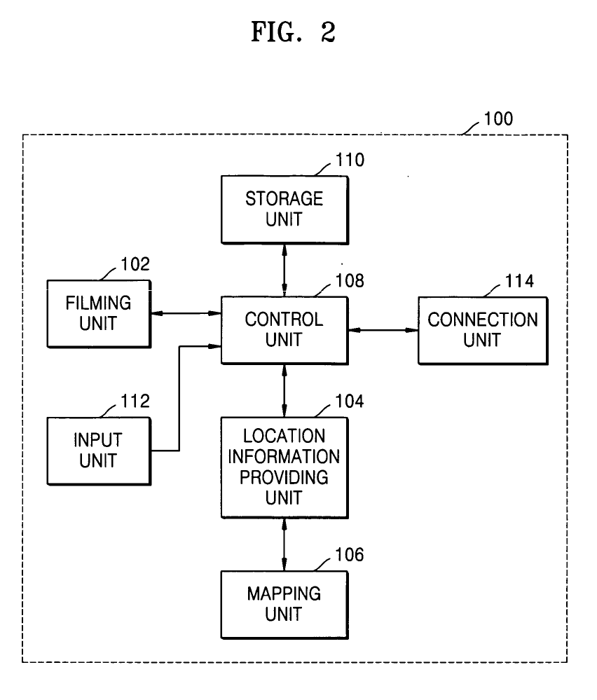

FIG. 2 is a block diagram illustrating a structure of an image photographing apparatus according to an embodiment of the present invention.

Referring to FIG. 2, the image photographing apparatus 100 according to an embodiment of the present invention comprises a filming unit 102, a location information providing unit 104, a mapping unit 106, a control unit 108, a storage unit 110, an input unit 112, and a connection unit 114. The image photographing apparatus to which embodiments of the present invention can be applied can include a digital camera, camcorder, smart phone, mobile phone, PMP, MP3 player, a navigation device, or other such devices.

The filming unit 102 takes a picture of an object and provides image data. For example, if the image photographing apparatus 100 is a digital camera, the filming unit 102 converts an image input through a lens into a digital signal by using a photoelectric conversion device, such as a charge coupled device (CCD), and outputs the signal. The image data provided by the filming unit 102 can be intermittent still images or continuous moving pictures.

The location information providing unit 104 provides location information on the location where the image data output from the filming unit 102 was taken. Here, the location information providing unit 104 can be constructed with a global positioning system (GPS) receiver that receives a GPS signal transmitted by GPS satellite and provides location information. In this case, the location information providing unit 104 receives the GPS signal and provides location coordinates (latitude and longitude) and altitude information based on the World Geodetic System 1984 (WGS-84). As described in greater detail below, the location information providing unit 104 can additionally receive a specific geographical name corresponding to location coordinates from the mapping unit 106 and output the name to the control unit 108.

More specifically, if a user command to take a picture is input through the input unit 112, the control unit 108 generates a GPS driving signal. When the GPS driving signal is received, the location information providing unit 104 outputs the location information of the place where the current image data is being taken, to the control unit 108. Here, even when the user's command to take a picture is not input, the location information providing unit 104 can continuously receive the GPS signal and provide location information.

In addition to the GPS receiver, the location information providing unit 104 can provide location information by using other location-based technologies, such as wireless LAN (WLAN), Bluetooth, and Zigbee.

The mapping unit 106 converts the coordinate information provided by the location information providing unit 104 into a geographical name that the user can easily recognize. That is, the mapping unit 106 provides a specific geographical name corresponding to the coordinates. When only coordinate information is provided, as in the case where the GPS receiver is used as the location information providing unit 104, it is difficult for the user to know the place where the image is taken using only the coordinate information. For example, the coordinates of Quebec, Canada, are latitude 46° 50′, north, and longitude 71° 15′, west. Therefore, it is difficult for the user to recognize the specific location from only the coordinate information. Accordingly, the mapping unit 106 stores specific geographical names corresponding to a variety of coordinate information, such as in tables for example. When coordinate information from the location information providing unit 104 is input, the mapping unit 106 provides a geographical name corresponding to the location information such that the user can easily recognize the place where the image is taken.

The mapping unit 106 is not necessarily contained in the image photographing apparatus according to embodiments of the present invention. For example, in an exemplary embodiment of the present invention, when an image is taken, only coordinate information is stored in an area of the image data. Then, when an external PC or the like is connected (synchronized) through the connection unit 114 in order to move the stored image data to an external storage device, a specific geographical name can be provided.

The control unit 108 controls the operation of each module by outputting control signals according to the operation command of the user provided through the input unit 112. Also, the control unit 108 adds the location information output from the location information providing unit 104 to a predetermined area of the image data output from the filming unit 102. As described in greater detail below, the control unit 108 adds the location information in a user comment area of meta data included in the image data.

When the name rule according to the DCF file format is not complied with, the control unit 108 can control the apparatus 100 such that the location information is included in the filename itself of the image data. When the user inputs a store command through the input unit 112, the image data to which the location information is added is stored in the storage unit 110. The storage unit 110 can comprise a flash memory, memory card, memory stick, floppy disk, rewritable optical disk, or other such device.

The input unit 112 receives operation commands from the user and can be implemented with a plurality of buttons and/or a touch screen.

The connection unit 114 can be connected to an external apparatus and provides a function for communicating with the eternal apparatus, That is, the connection unit 114 connects the image photographing apparatus 100 according to embodiments of the present invention to an external apparatus such as a computer or a notebook computer, and can transmit image data taken by the image photographing apparatus 100 to the external apparatus and can receive specific geographical information and the like from the external apparatus.

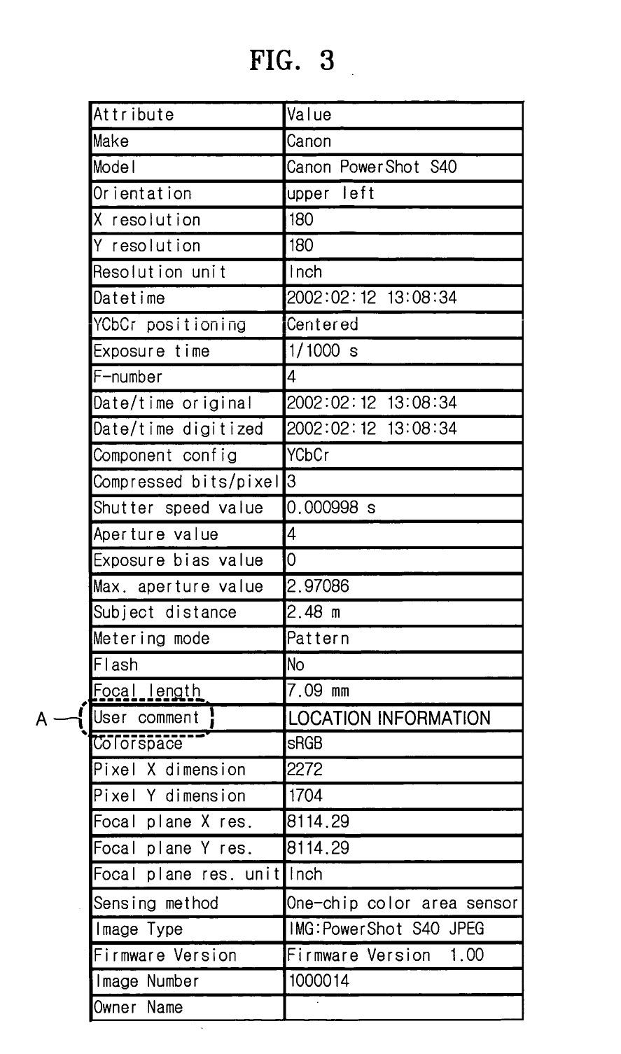

FIG. 3 illustrates an example of a meta data format for image data taken by the image photographing apparatus 100 according to an embodiment of the present invention. Here, as is widely known by those skilled in the art, the meta data is data inserted into the image data in order to provide additional information on the image data.

Referring to FIG. 3, the meta data includes a variety of additional information items, such as the manufacturer of the apparatus, the product model of the apparatus, the resolution of the image data, and the time at which the image was taken. The user comment area in the meta data part complying with the DCF file format is an area that can be used freely.

Accordingly, the image photographing apparatus 100 according to embodiments of the present invention additionally stores the location information provided by the location information providing unit 104 in the user's comment area of the meta data, such that the information of the place where an image is taken is provided.

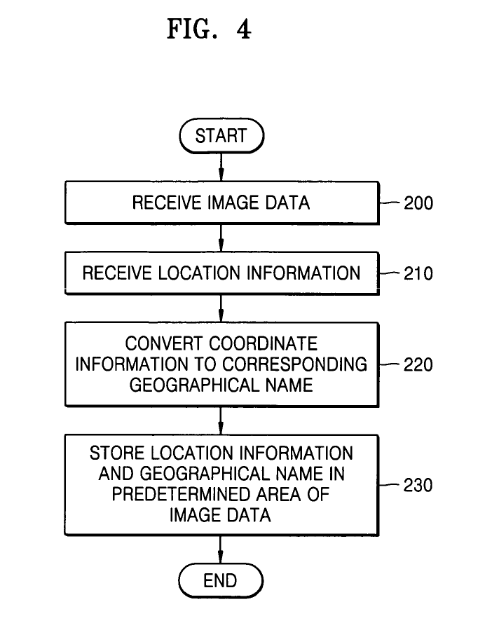

FIG. 4 is a flowchart illustrating an embodiment of a method of storing image data of the image photographing apparatus 100 according to an embodiment of the present invention.

Referring to FIG. 4, when the user takes a photo, image data is received through the filming unit 102 in operation 200. If the user selects to store the image, the control unit 108 receives the location information of the place where the current image is taken from the location information providing unit 104 in operation 210. As described above, when the mapping unit 106 is located in the image photographing apparatus 100 according to embodiments of the present invention, the mapping unit 106 converts the coordinates of the current location to a specific geographical name corresponding to the coordinates in operation 220.

The control unit 108 adds the location information provided by the location information providing unit 104 to the user comment area of the meta data, and stores the data in operation 230. When the mapping unit 106 is included, the coordinate information and the specific geographical name corresponding to the coordinates are stored together. When the mapping unit 106 is not included or is provided elsewhere, such as in an external computer, only the coordinate information is stored.

In the image data storing method of the image photographing apparatus according to embodiments of the present invention described above, the filename according to the DCF file format is not changed and the location information is added to the user comment area of the meta data.

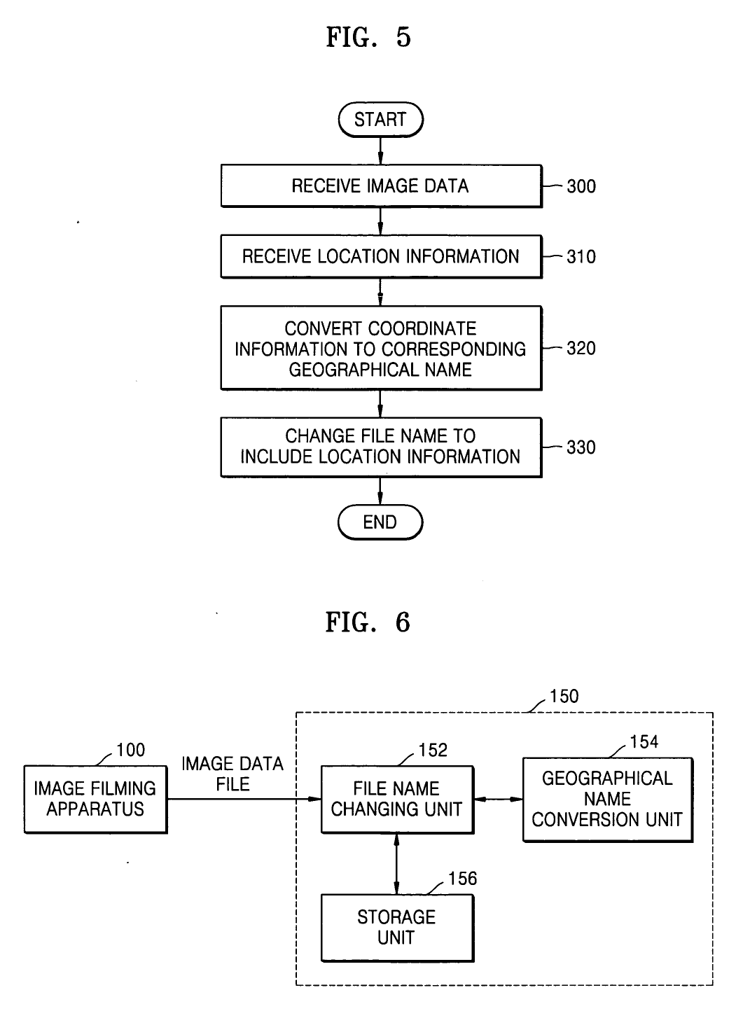

FIG. 5 is a flowchart illustrating an embodiment of a method of storing image data of an image photographing apparatus according to another embodiment of the present invention. When the naming rule complying with the DCF file format is not followed, a filename can be changed when a file is stored, so that location information can be included in the filename itself.

Referring to FIG. 5, operations 300 through 320 are similar to corresponding operations 200 through 220 in FIG. 4. However, in the image data storing method described with reference to FIG. 4, the naming rule complying with the DCF standard is applied and the filename itself is not changed, while in the image data storing method of FIG. 5, the naming rule complying with the DCF file format is not followed and the location information is included in the filename itself. That is, if the location information of an image is received, when the image data is stored, the filename is changed to include the location information in the filename in operation 330. Here, the filename can comprise time information and other information in addition to the location information according to the selection of the user. For example, an image taken at Yongin Everland amusement park on Dec. 25, 2004, at 12:30 PM, can be stored with a filename, “SA500123-20041225-1230-Everland.JPG”. Here, ‘SA500123’ denotes a filename complying with the DCF file format automatically given in the image photographing apparatus, and ‘20041225’, ‘1230’, and ‘Everland’ respectively indicate the date, time, and place that the photo was taken. The types and order of information items included in the filename can be changed according to the selection of the user.

FIG. 6 is a block diagram illustrating an image photographing apparatus connected to a computer apparatus, according to an embodiment of the present invention.

Generally, since there is a limit to the storage capacity of the image photographing apparatus 100, an image data file stored in the image photographing apparatus 100 is moved to a computer apparatus 150, such as a PC or a notebook, and stored therein.

Referring to FIG. 6, the computer apparatus 150 comprises a filename changing unit 152, a geographical name conversion unit 154, and a storage unit 156.

Assuming, for example, that location information of the place where an image was taken is included in the user comment area of the meta data of the image data transmitted from the image photographing apparatus 100 as described above, the filename changing unit 152 extracts the location information. The filename changing unit 152 changes the filename of the image data so that the extracted location information is included in the filename. As in the example described above, the name of the image data taken at Yongin Everland amusement park, Dec. 25, 2004, 12:30 PM, is changed into “SA500123-20041225-1230-Everland.JPG”. Here, the types and order of information items included in the filename can be changed according to the selection of the user.

Thus, the filename is not changed in the image photographing apparatus 100 itself, but is changed in the computer apparatus 150 after being transmitted from the image photographing apparatus 100. This is because the naming rule for setting a filename complying with the DCF standard limits the changing of the filename. By changing the filename in the computer apparatus, which is not dependent on the naming rule, the management of the image data taken by the user can be made easier, while complying with the DCF standard.

The location information may not include a specific geographical name, but only the coordinate information of the place where the image was taken. The geographical name conversion unit 154 stores a specific geographical name corresponding to the coordinate information in the form of a table or similar database, searches for the geographical name corresponding to the coordinate information, and provides the geographical name to the filename changing unit 152. Here, when the geographical name conversion unit 154 is not included, the specific geographical name can be searched for through a network.

The image data file whose name is changed by the filename changing unit 152 is then stored in the storage unit 156.

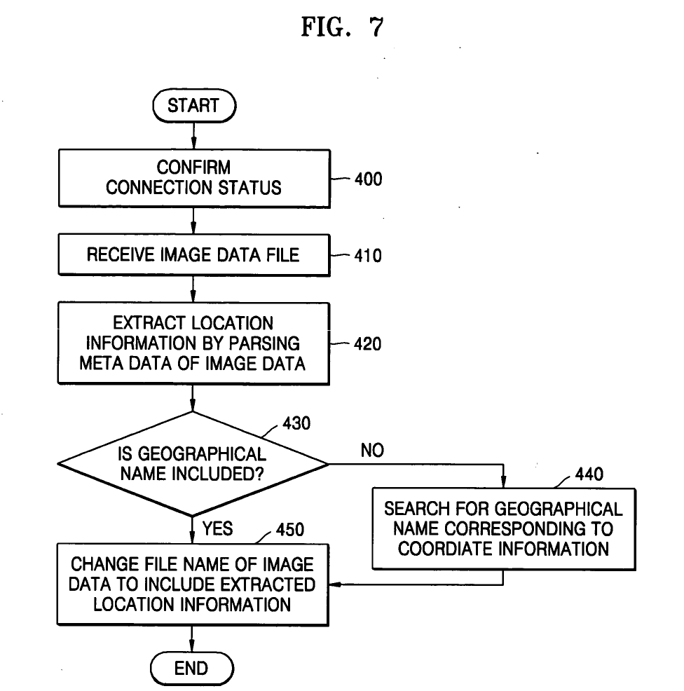

FIG. 7 is a flowchart illustrating a process of transmitting and receiving data between an image photographing apparatus and a computer apparatus, and changing a file name according to an embodiment of the present invention.

The computer apparatus connected to the image photographing apparatus confirms the status of the connection in order to determine whether or not data can be transmitted and received in operation 400.

Next, an image data file transmitted by the image photographing apparatus is received in operation 410.

The meta data of the image data file is parsed and location information stored in the user comment of the meta data is extracted in operation 420.

Next, it is determined whether or not a specific geographical name of the place where the image data was taken is included in the location information in operation 430. As described above, the location information can include only coordinate information or can include the coordinate information together with specific geographical name information corresponding to the coordinate information. When only the coordinate information is included, the geographical name corresponding to the coordinate information is searched for in operation 440, because even though the coordinate information is included, the user may not be able to identify the specific location of the image.

Next, the filename of the image data is changed so that the filename includes the extracted location information in operation 450.

When the process of changing the filename of the image data is implemented by software, the user sets a filename changing rule in an initial stage, and when the image photographing apparatus is connected to the computer, the changing of the filename can be performed automatically according to the rule set by the user.

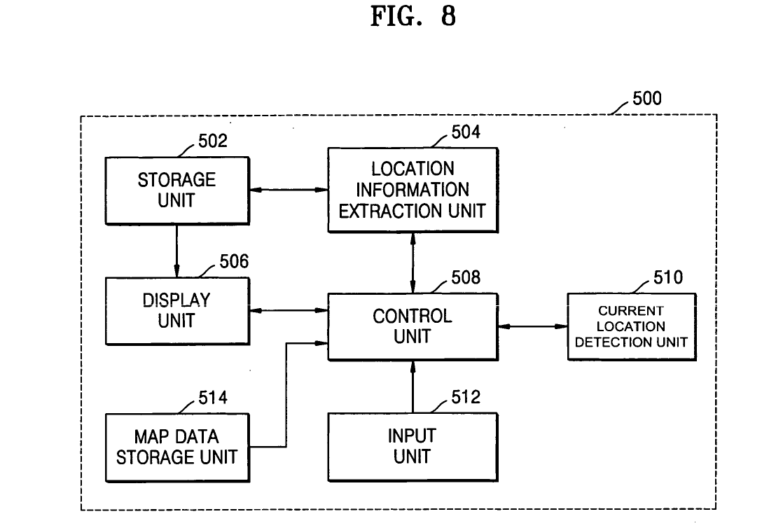

FIG. 8 is a block diagram illustrating a navigation apparatus using location information included in image data according to an embodiment of the present invention. By using the location information included in the image data, navigation can be made more effective and convenient.

In the navigation apparatus according to embodiments of the present invention, the user views an image on a display unit and if the image is selected by the user, a path from the current location to the place where the image was taken is provided by using the location information included in the image data.

Referring to FIG. 8, the navigation apparatus according to embodiments of the present invention comprises a storage unit 502, a location information extraction unit 504, a display unit 506, a control unit 508, a current location detection unit 510, an input unit 512, and a map data storage unit 514.

The storage unit 502 stores image data including location information described above. The location information extraction unit 504 extracts the location information included in the meta data area of the image data.

The map data storage unit 514 comprises a CD-ROM, hard disk drive, RAM, or the like, and stores map data.

The current location detection unit 510 comprises a GPS information reception unit, a Gyro sensor, and a speed sensor.

The current location detection unit 510 detects the current location of the navigation apparatus and transfers the result to the control unit 508.

The display unit 506 and the input unit 512 provide an interface between the user and the navigation apparatus. The input unit 512 comprises a keypad and/or a remote controller so that the user can select a variety of operation modes of the navigation apparatus, and transfers the user's selection information to the control unit 508.

Here, the image data stored in the storage unit 502 is displayed on the display unit 506, and if the user wants to go the to place where the current image was taken, the user can select a command through the input unit 512 to display a path from the current location to the place where the image was taken.

If the user selects the image displayed on the display unit 506, the control unit 508 calculates the path by using the location information on the place where the image was taken, provided by the location information extraction unit 504, and the current location provided by the current location detection unit 510, and then displays the calculated path on the display unit 506.

According to embodiments of the navigation apparatus having the structure described above, the image data is linked to the navigation such that the user can easily find the desired place.

Embodiments of the present invention can also be embodied as computer-readable code on a computer-readable recording medium. The computer-readable recording medium comprises any data storage device that can store data which can be thereafter read by a computer system. Examples of the computer-readable recording medium include read-only memory (ROM), random-access memory (RAM), CD-ROM, magnetic tape, floppy disk, optical data storage device, and carrier wave (such as data transmission through the Internet). The computer-readable recording medium can also be distributed over network coupled computer systems so that the computer-readable code is stored and executed in a distributed fashion.

According to embodiments of the present invention as described above, the user can reduce the searching time by creating and using filenames including the location information when the image data is retrieved.

Also, according to embodiments of the present invention, image data can be arranged and stored as the user desires, so that the image data can be managed efficiently.

Furthermore, according to embodiments of the present invention, the image data is linked to the navigation so that the user can find the place where an image was taken simply by viewing the image.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments of the present invention should be considered in a descriptive sense only and not for purposes of limitation. Therefore, the scope of embodiments of the present invention is defined not by the detailed description of the present invention but by the appended claims and their equivalents, and all differences within the scope will be construed as being included in the present invention.

What is claimed is:

1. An image photographing apparatus, comprising:
a filming unit, for photographing an object and providing image data;
a location information providing unit, for providing location information of a place where the image data is taken;
a control unit, for adding the location information to a predetermined area of the image data; and
a storage unit, for storing the image data according to control of the control unit.

2. The apparatus of claim 1, wherein the location information providing unit is configured to receive a global positioning system (GPS) signal and provide location information.

3. The apparatus of claim 1, wherein the predetermined area in which the location information is added comprises a user comment area of meta data.

4. The apparatus of claim 1, wherein the control unit is configured to change the filename of the image data so that the location information is included in the filename.

5. The apparatus of claim 1, further comprising:
a mapping unit, for receiving an input of coordinate information from the location information providing unit and providing a specific geographical name corresponding to the coordinate information.

6. The apparatus of claim 5, wherein the mapping unit is configured to store the geographical name corresponding to the coordinate information.

7. The apparatus of claim 6, wherein the mapping unit is configured to store the geographical name corresponding to the coordinate information in a table.

8. A method of storing image data taken in an image photographing apparatus, comprising the steps of:
receiving image data;
receiving location information of a place where the image data is taken; and
adding the location information to a predetermined area of the image data.

9. The method of claim 8, wherein the predetermined area comprises a user comment area of meta data.

10. The method of claim 8, wherein the location information comprises at least one of coordinate information and a specific geographical name corresponding to the coordinate information.

11. The method of claim 8, further comprising the step of:
searching for a specific geographical name corresponding to coordinate information if only the coordinate information is included in the location information.

12. A method of storing image data taken in an image photographing apparatus, comprising the steps of:
receiving image data;
receiving location information of a place where the image data is taken; and
changing a filename so that the location information is included in a predetermined area of the filename of the image data.

13. The method of claim 12, wherein the predetermined area comprises a user comment area of meta data.

14. The method of claim 12, wherein the location information comprises at least one of coordinate information and a specific geographical name corresponding to the coordinate information.

15. The method of claim 12, further comprising the step of:
searching for a specific geographical name corresponding to coordinate information if only the coordinate information is included in the location information.

16. An apparatus for receiving and storing a transmitted image data file taken in an image photographing apparatus, the apparatus comprising:
a filename changing unit, for extracting location information on a place where image data is taken by parsing location information included in a predetermined area of an image data file, and for changing a filename so that the location information is included in the filename of the image data; and
a storage unit, for storing the image data file whose filename is changed.

17. The apparatus of claim 16, wherein the predetermined area of the image data file comprises a user comment area of meta data.

18. The apparatus of claim 16, further comprising:
a geographical name conversion unit, for searching for a specific geographical name corresponding to coordinate information included in the location information and providing the geographical name.

19. A method of receiving and storing a transmitted image data file taken in an image photographing apparatus, the method comprising the steps of:
receiving an image data file from an image photographing apparatus;
extracting location information from a predetermined area of the image data file; and
changing a filename of the image data file so that the extracted location information is included in the filename of the image data file.

20. The method of claim 19, wherein the predetermined area of the image data file comprises a user comment area of meta data.

21. The method of claim 19, further comprising the step of:
searching for a specific geographical name corresponding to coordinate information if only the coordinate information is included in the location information.

22. A navigation apparatus, comprising:
a storage unit, for storing an image data file including location information in a predetermined area therein;
a location information extraction unit, for extracting the location information from the image data file;
a current location detection unit, for providing current location information;
a display unit, for displaying the image data file; and
a control unit, for calculating a path to a destination where the image was taken by using the current location information provided by the current location detection unit and the location information stored in the image data file if an image displayed on the display unit is selected as a destination.

23. The navigation apparatus of claim 22, wherein the predetermined area of the image data file including the location information comprises a user comment area of meta data.
